(19) United States
(12) Patent Application Publication
(10) Pub. No.: US 2009/0127221 A1
(43) Pub. Date: May 21, 2009

(54) Baby Bottle to go

(76) Inventor: Nadeem Victor Nasrallah, Crown Point, IN (US)

Correspondence Address: NADEEM V. NASRALLAH, 11095 OREGON LANE, CROWN POINT, IN, 46307, US

(21) Appl. No.: 12/005,260

(22) Filed: Dec. 27, 2007

Related U.S. Application Data
(60) Provisional application No. 60/894,480, filed on Mar. 13, 2007.

(51) Int. Cl. A61J 9/08; A61J 9/00; A61J 11/00

(52) U.S. Cl. 215/11.6; 215/11.1; 606/236

(57) ABSTRACT

A feeding baby bottle comprises a bottle, a nipple, a threaded cap for clamping the nipple to the bottle, a removable cover member associated with the nipple and cap for protecting the nipple against contamination and an attachable lower compartment for powder storage and until the bottle is used for feeding. The lower attachable compartment stores and dispenses a pre-measured amount of powdered milk sufficient for a single full bottle feeding.

### CROSS-REFERENCE TO RELATED APPLICATIONS

Application No. 60/894,480
Filing date: Mar. 13, 2007
Invention Title: Baby Bottle To Go
Inventor Nadeem Victor Nasrallah

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable

### BACKGROUND OF THE INVENTION

The common process used to feed babies with the use of a baby feeding bottle, the bottle is filled with water, and formula is added to the water at the time the baby is to be fed. This process is essentially useful when the baby is to be fed during car trips or visits away from home, and when refrigeration may not be available so the baby can be fed without worrying about whether the milk has spoiled. Until the baby bottle is utilized, its cleanliness is protected by the end cap covering the nipple. When feeding time comes, formula is mixed with the water and the baby is fed.

At feeding time, the bottle is opened exposing the water and a measured amount of formula is dispensed into the bottle and combined with the water. The formula itself is usually carried in a separate bulky container that contains a measuring spoon. The said container is carried separately with the water filled baby bottle, and the measuring spoon is used to dispense the measured amount of formula into the baby bottle. The bottle is closed and agitated to allow the mixing of the formula with the water. The nipple cap remains covering the nipple during this process.

This process results in having to carry several heavy and bulky items wherever a baby needs to be fed away from home. Items to be carried on a trip, visit or a day at the park includes a heavy gallon of water, a heavy container of formula and several baby bottles resulting in the need for extra carrying space and helping hands. Products have been invented to deal with this issue such as washable and refillable containers and others carry portions of formula, but still in a separate container that needs to be carried. As well, such containers have limited compartments that sometimes do not match the number of bottles carried, resulting in being unable to use all baby bottles needed for that particular trip.

The present invention eliminated all issues relating to carrying bulky containers of formula and bulky gallons of water on a trip away from home or even on a trip to the local park or mall. This invention provides a baby bottle designed to allow to only carry the exact needed amount of water, formula and bottles needed for a certain trip. The measure of formula needed for each bottle is carried along with that same bottle. This effectively eliminates the need to carry any additional gallons of water and formula containers that are not needed.

### BRIEF SUMMARY OF THE INVENTION

This invention relates to baby feeding bottles, and particularly the type used with powdered formula. The invention is a baby feeding bottle that comprises a bottle, a nipple, a threaded cap for clamping the nipple to the bottle, a removable cover member associated with the nipple and cap for protecting the nipple against contamination and an attachable lower compartment for powder storage and until the bottle is used for feeding. The lower attachable compartment stores and dispenses a pre-measured amount of powdered milk sufficient for a single full bottle feeding.

### BRIEF DESCRIPTION OF THE SEVERAL VIEWS OF THE DRAWINGS

FIG. 1 is a detail view of the baby bottle, in its assembled form, containing the separated water and formula.

FIG. 2 is a detailed view of the baby bottle, with lower compartment unscrewed.

FIG. 3 is a view of lower compartment that houses the formula, detailed of FIG. 2.

FIG. 4 is a view of the bottle at the mixing stage between the contents of the lower compartment (formula) and the content of the upper compartment (water).

### DETAILED DESCRIPTION OF THE INVENTION

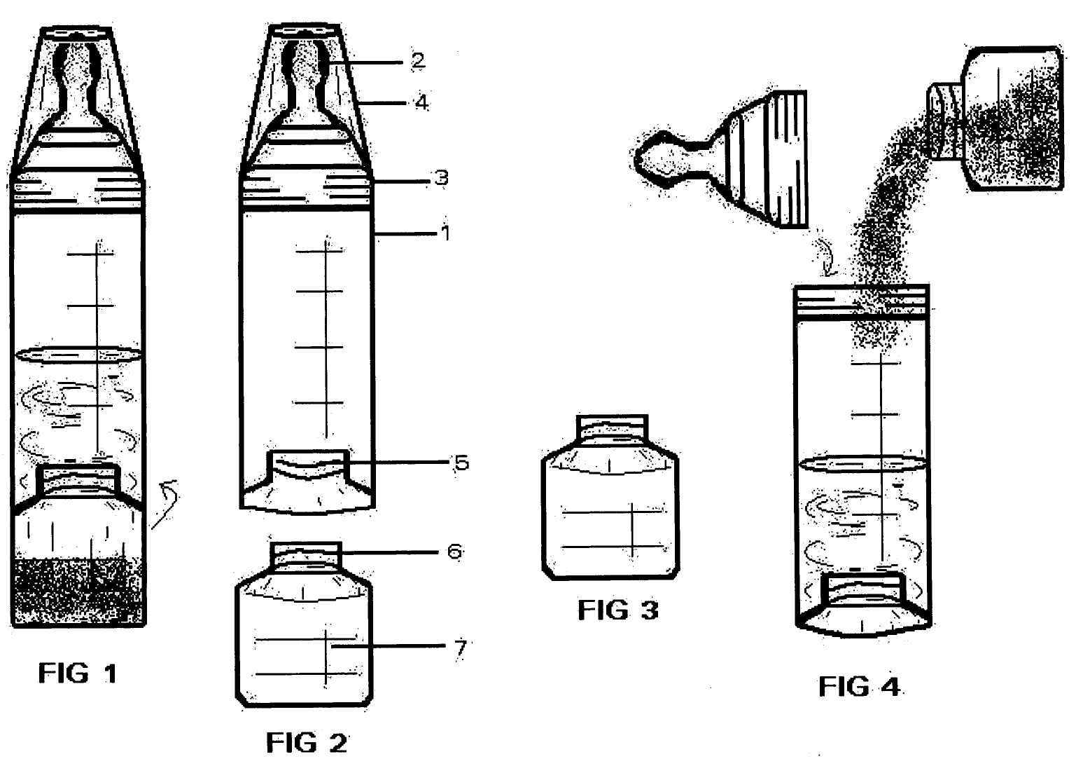

Thus, in FIG. 1 the invention baby bottle is shown in its assembled form and having the upper compartment containing the pre-measured amount of water and the lower compartment containing the pre-measured amount of formula. Both compartments are sealingly attached together through their threaded portions. FIG. 2.1 shows the bottle proper in its assembled form. FIG. 2 shows the invention baby bottle with its lower compartment detached from the upper compartment. FIG. 2.2 points at the rubber nipple sealingly attached to the upper compartment by the threaded cap shown in FIG. 2.3. FIG. 2.4 points at the releasable cover-to-cap member that is associated with the nipple and baby bottle cover for covering and protecting the nipple against contamination until the baby bottle is ready for use. FIG. 2.5 points at the bottom wall (base of the upper bottle) comprising of an inverted threading at the center of the base and is tapered at an upward angle. FIG. 2.6 points at the lower compartments threaded tapered top that sealingly screws onto the threaded portion at the bottom center of the baby bottle (upper compartment), forming a uniform shape with the bottle. FIG. 2.7 points at the detached lower compartment. FIG. 3 points at a detached lower compartment. FIG. 4 is a view of the bottle at the mixing stage between the contents of the lower compartment (formula) and the content of the upper compartment (water).

When the bottle is to be given to the baby, the clamping member or cap FIG. 2.3 is unscrewed and, along with the nipple FIG. 2.2 and cover-to-cap FIG. 2.4 is removed from the upper compartment FIG. 2.1, and the lower compartment FIG. 2.7 is unscrewed and detached from the upper compartment. The pre-measured formula in the lower compartment is poured into the pre-measured amount of water present in the upper compartment FIG. 4. The clamping member or cap along with the nipple are screwed back into place and the cover-to-cap is snapped back on the nipple. The bottle is agitated causing the contents to mix and the bottle is ready to be used.

The invention makes it convenient to carry only the necessary amount of baby bottle, formula and water for certain trips without having to carry the extra weight and space needed that are associated with bulky containers. Exact amount of pre-measured baby bottles are prepared before a trip in accordance to the length of the trip.

This disclosure is by way of example and variations in addition to those mentioned above may be made by adding, modifying or eliminating details without departing from the fair scope of the teaching contained in this disclosure. The invention is not limited to particular details of this disclosure except to the extent that the following claims are necessarily so limited.

What is claimed is:

1- A nurser baby bottle comprised of a container being a baby's feeding bottle that houses two separate attachable compartments: an upper and a lower compartment.

2- The upper compartment comprises a nipple, a threaded cap that screws onto the baby bottle for closing and sealingly clamping the nipple thereto, and a releasable cover-to-cap member that is associated with the nipple and baby bottle cover for covering and protecting the nipple against contamination until the baby bottle is ready for use. This upper compartment holds the pre-measured mixing fluid, and has a bottom wall that creates an isolated chamber for the said upper compartment. The bottom wall (base of the bottle) comprises an inverted threading at the center of the base and is tapered at an upward angle.

3- The lower compartment is essentially another shorter bottle that screws onto the base of the upper compartment. The lower compartment comprises a smaller diameter size threaded top that sealingly screws onto the threaded portion at the bottom center of the baby bottle (upper compartment), forming a uniform shape with the bottle. When attached together, the upper and lower compartment result in one uniform shaped bottle. The lower compartment is a walled storage chamber for storing pre-measured powdered formula. The dispensing top end of the lower compartment comprises of a tapered threaded neck portion forming a constricted outlet in an otherwise cylindrical container. Bottom compartment sealingly screws onto the bottom of the upper bottle preventing the powder from leaking out of the lower compartment.

4- When ready to use, simply unscrew the top bottle nipple cap in order to expose the mixing fluid that has been pre-measured and filled into the upper compartment, unscrew the lower compartment separating it from the upper compartment and pour the pre-measured formula into the upper compartment. Sealingly screw the top bottle nipple cap back onto the baby bottle, close the protective cover and shake the bottle to mix the contents. Baby bottle is ready for use.

5. A container according to claim 1, being a baby's feeding bottle wherein said baby feeding bottle comprises two compartments.

6. A container according to claim 1, wherein said component of top compartment is a liquid and said second component of lower compartment is a powdered formulation.

7. A container according to claim 2, wherein said partition wall is independent from lower compartment.

8. A container according to claim 3, wherein said partition wall is independent from upper compartment.

9. A container according to claim 3, wherein the neck portion is formed as a constricted portion in an otherwise cylindrical container.

10. A container according to claim 3, wherein said compartment has a threaded and constricted opening sealably engaged at the center bottom end of top compartment by screwing ends together.

11. A container according to claim 3, wherein said constricted outlet opening allows filling of the lower compartment with pre-measured powdered formula.

12. A method according to claim 4, for the preparation of a liquid formulation from a prior two individual components, the method comprising:
(a) providing a container according to claim 1, with each of the two components being stored in one of the container's two compartments;
(b) separating lower compartment from upper by unscrewing lower compartment;
(c) unscrewing lower compartment from upper and introducing powder from lower compartment into the liquid inside upper compartment, and sealing said compartment;
(d) agitating the upper compartment to mix the two components into said formulation.
